(19) United States
(12) Patent Application Publication
(10) Pub. No.: US 2022/0416579 A1
(43) Pub. Date: Dec. 29, 2022

(54) SYSTEMS AND METHODS FOR WIRELESS CHARGING USING A SPEAKER COIL

(71) Applicant: META PLATFORMS TECHNOLOGIES, LLC, Menlo Park, CA (US)

(72) Inventor: Tony David, San Jose, CA (US)

(21) Appl. No.: 17/697,797

(22) Filed: Mar. 17, 2022

Related U.S. Application Data
(60) Provisional application No. 63/216,460, filed on Jun. 29, 2021.

(51) Int. Cl. H02J 50/10; H04R 1/10; H04R 9/06; H04R 9/04; H02J 7/00

(52) U.S. Cl. CPC H02J 50/10; H04R 1/1025; H04R 1/1041; H04R 1/1008; H04R 9/06; H04R 9/046; H02J 7/00032; H04R 2420/07; H04R 2499/15; H04B 5/0037

(57) ABSTRACT

A device and method for wireless charging user a speaker coil. In one embodiment, a device may include a processor, memory, at least one speaker coil configured to reproduce audio signals and receive wireless power from a wireless power source, and a switch configured to switch the at least one speaker coil between reproducing the audio signals and receiving the wireless power from the wireless power source. A method may include identifying a device that includes at least one speaker coil, receiving, via the at least one speaker coil, audio signals, and receiving, via the at least one speaker coil, wireless power. Various other methods, systems, and computer-readable media are also disclosed.

### CROSS REFERENCE TO RELATED APPLICATION

This application claims the benefit of priority under 35 U.S.C. § 119(e) to U.S. Provisional Application No. 63/216,460, filed 29 Jun. 2021, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for wireless charging using a speaker coil.

FIG. 2 is a flow diagram of an exemplary method for wireless charging using a speaker coil.

FIG. 3 is an illustration of a single speaker coil controlled by a logic chip.

FIG. 4 is an illustration of dual speaker coils each with different purposes.

FIG. 5 is an illustration of a device with a speaker coil on a charging dock.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

This present disclosure is generally directed to methods and systems for using a speaker coil to perform wireless charging. Some systems use pogo pins to connect electronic devices (e.g., artificial reality glasses) to docking stations. These pogo pins may facilitate wired electrical charging and/or data transfer. In one example, artificial reality (AR) glasses may be placed on pogo pins within a docking station to charge the glasses and to transfer data to and from the AR glasses. Pogo pins, however, require the glasses (or other electronic devices) to be placed in a specific position so that the pins of the device match the physical connectors of the docking station. Moreover, these pogo pins may begin to degrade over time, such that the connection between the electronic device and the docking station becomes temperamental or ceases to function entirely.

In contrast, the systems described herein may use speaker coils to perform wireless charging and/or data transfer. At least in some cases, these speaker coils may be speaker coils that already exist within the electronic device. For instance, AR devices such as glasses or head-mounted displays may already have speaker coils in the device (e.g., in each arm of the glasses) to convey sound to the wearer of the device. In some embodiments, these speaker coils may be designed to not only play back audio but also to perform wireless charging and/or data transfer.

In some embodiments, the systems described herein may improve the functioning of a computing device by enabling the computing device to charge and/or transfer data wirelessly. Additionally, the systems described herein may improve the fields of artificial reality and/or audio devices by enabling devices to use speaker coils for both reproducing audio and wirelessly charging, resulting in devices that are more user-friendly, more resilient, and/or smaller.

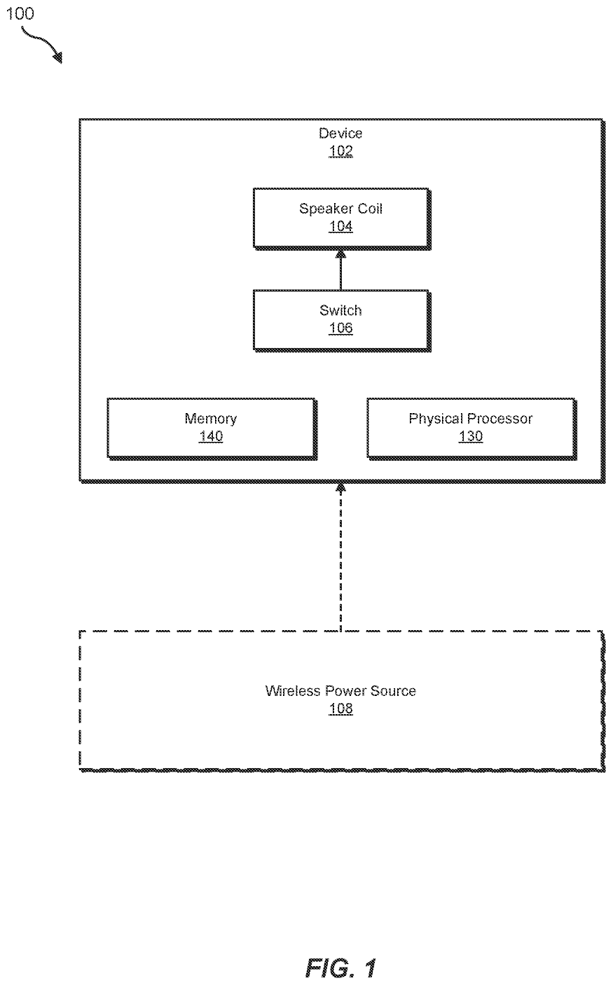

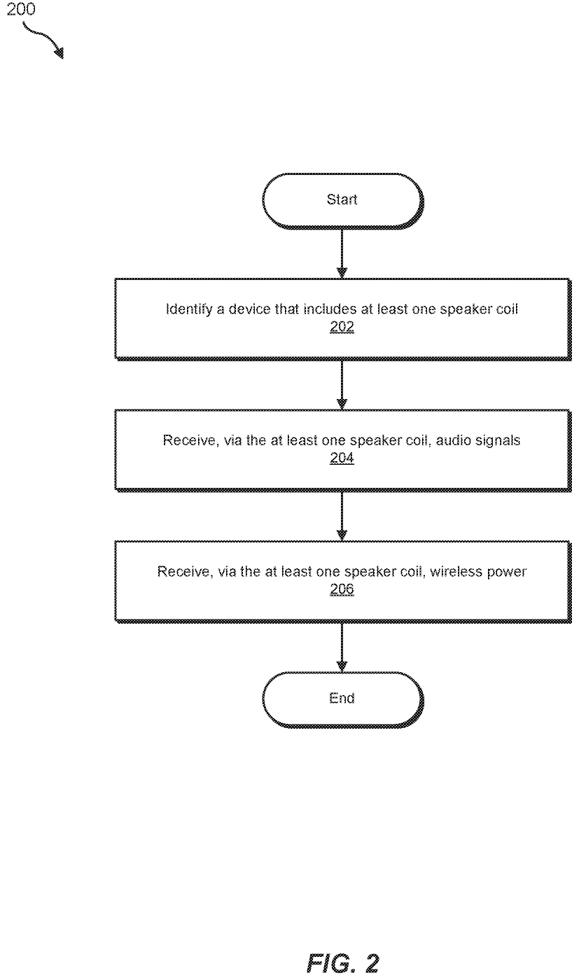

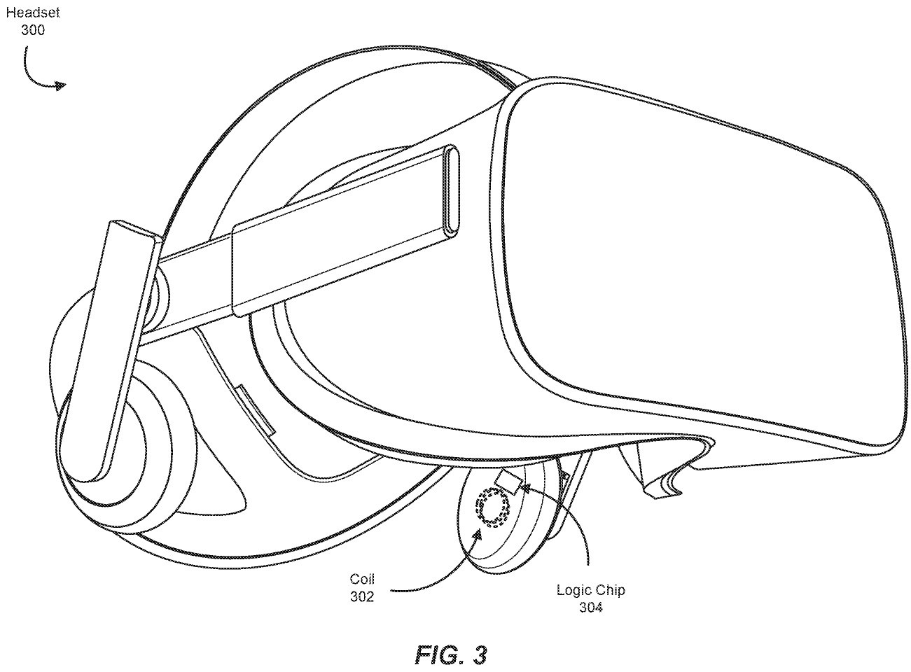

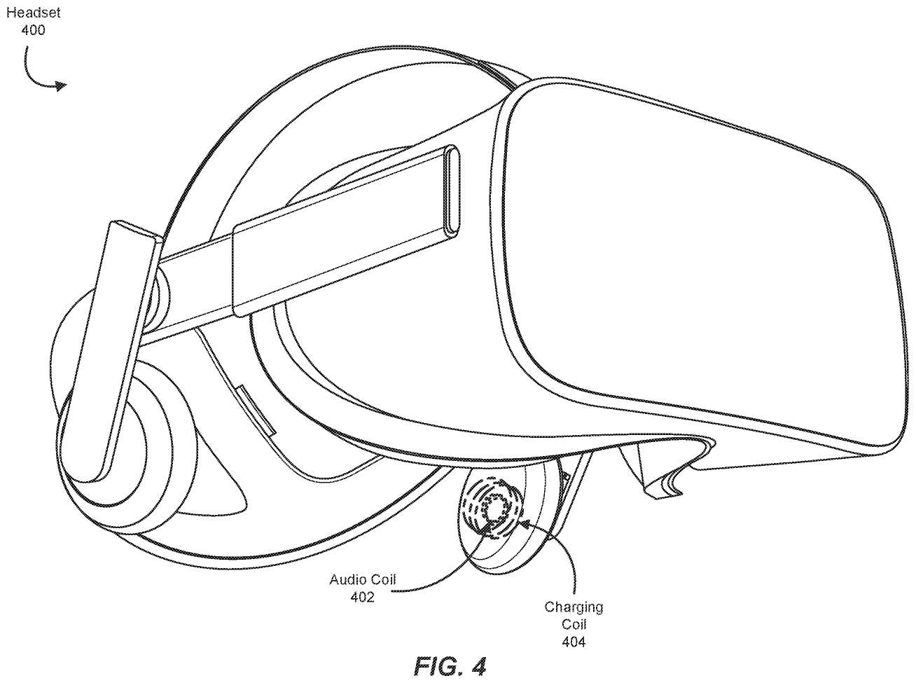

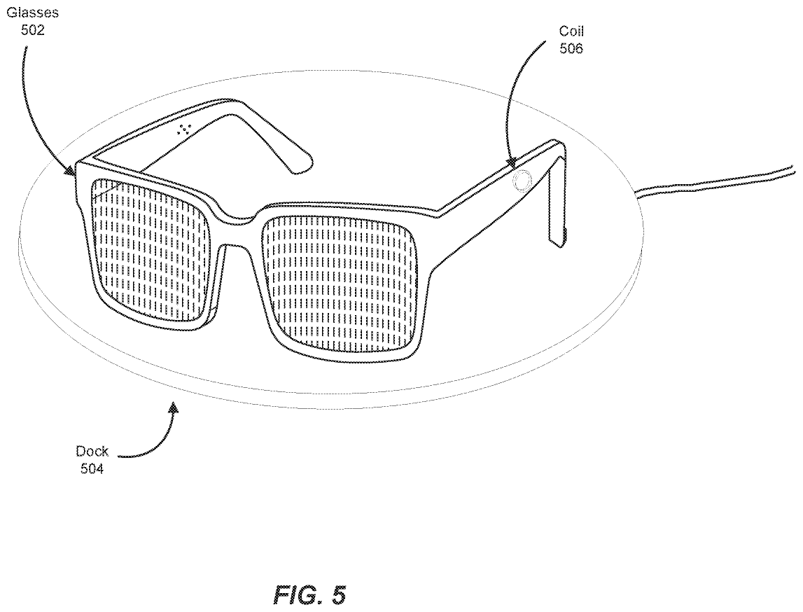

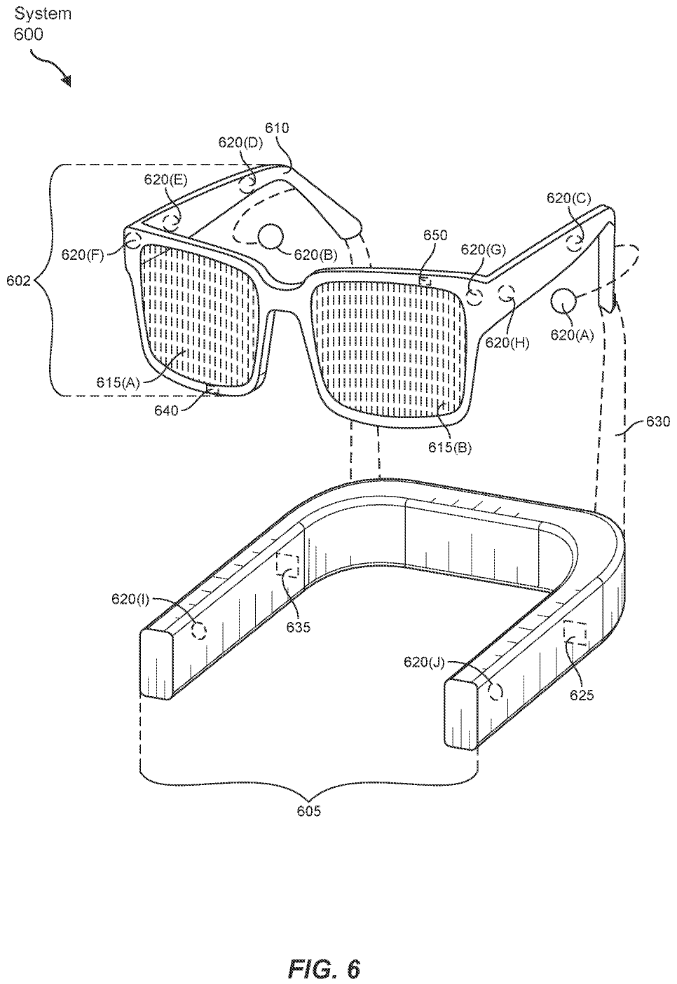

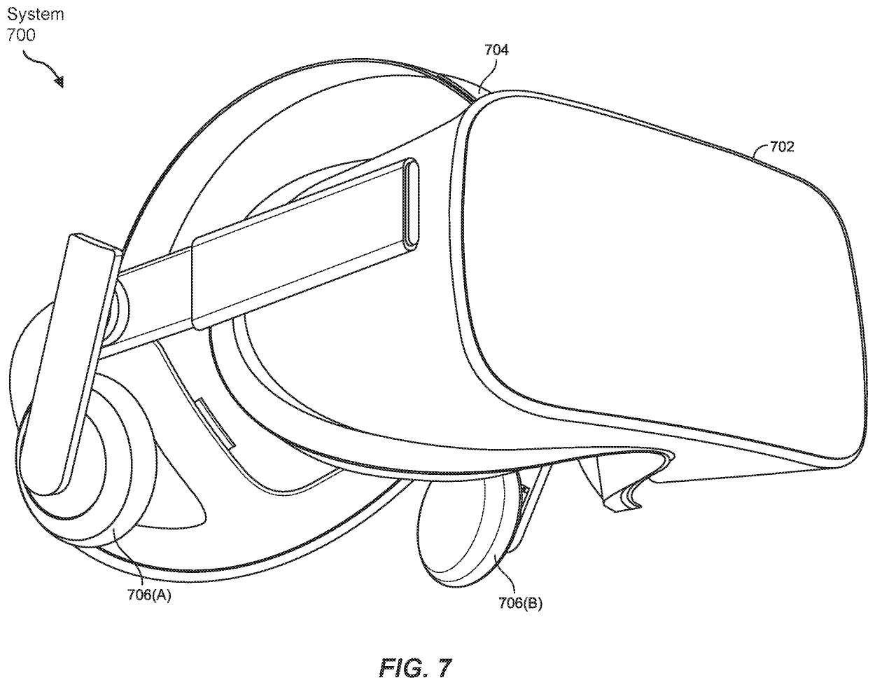

The following will provide detailed descriptions of systems and methods for wireless charging using a speaker coil with reference to FIGS. 1 and 2, respectively. Detailed descriptions of a single speaker coil controlled by a logic chip will be provided in connection with FIG. 3 while detailed descriptions of dual speaker coils with different purposes will be provided in connection with FIG. 4. Additionally, detailed descriptions of a device with a speaker coil on a charging dock that provides wireless power and/or communication will be provided in connection with FIG. 5. Detailed descriptions of augmented reality and/or virtual reality embodiments will be provided in connection with FIGS. 6 and 7.

In some embodiments, the systems described herein may enable wireless charging and/or data transfer via one or more speaker coils within a device. FIG. 1 is a block diagram of an exemplary system 100 for wireless charging using a speaker coil. In one embodiment, and as will be described in greater detail below, a device 102 may be configured with a speaker coil 104. In some embodiments, device 102 may be configured with a switch 106 that switches speaker coil 104 between audio and charging modes. In other embodiments, device 102 may be configured with two speaker coils. In some examples, device 102 may receive wireless power from a wireless power source 108 via speaker coil 104.

Device 102 generally represents any type or form of computing device capable of reading computer-executable instructions and reproducing audio. For example, device 102 may represent a device intended to be worn on a user's head, such as headphones, a headset, and/or glasses. In some embodiments, device 102 may be an AR device. Additional examples of device 102 may include, without limitation, a laptop, a desktop, a wearable device, a smart device, etc.

Speaker coil 104 generally represents any coil of wire within a device. In some embodiments, speaker coil 104 may be an electromagnetic coil. Speaker coil 104 may be designed (e.g., in terms of radius, length, material, angle of coil, etc.) to reproduce audio and/or to facilitate wireless charging. In some embodiments, speaker coil 104 may be made of copper or other conductive compounds.

Switch 106 generally represents any device component capable of switching speaker coil 104 between different modes. In some embodiments, switch 106 may include a computing chip, such as a logic chip. In one embodiment, switch 106 may operate and/or be part of a physical processor 130.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more software modules. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

FIG. 2 is a flow diagram of an exemplary method 200 for wireless charging using a speaker coil. In some examples, at step 202, the systems described herein may identify a device that includes at least one speaker coil.

The systems described herein may identify various types of devices that include at least one speaker coil. For example, the systems described herein may identify a pair of headphones, a pair of glasses, or a headset that includes at least one speaker coil. In some embodiments, a device may include two similar or identical speaker coils positioned bilaterally, such as a pair of glasses that includes a speaker coil in each arm or a pair of headphones that includes a speaker coil in each earpiece.

In some examples, at step 204, the systems described herein may receive, via the at least one speaker coil, audio signals.

The systems described herein may receive audio signals in a variety of ways and/or contexts. For example, the systems described herein may be part of an AR system that receives audio signals representing sounds happening in an AR environment. In another example, the systems described herein may receive audio signals representing music. In some embodiments, the speaker coils may reproduce sounds for a wearer of the device. In some examples, the systems described herein may receive the audio signals and switch from a power receiving mode into an audio receiving mode.

In some examples, at step 206, the systems described herein may receive, via the at least one speaker coil, wireless power.

In some embodiments, the systems described herein may receive the wireless power at a separate time from when the systems described herein receive the audio signals. For example, an AR headset may receive audio signals while the AR headset is in active use (e.g., worn by a user who is engaging in AR activities, such as a game or social media) and may receive wireless power while the AR headset is not in use (e.g., placed on or near a wireless docking station). In some examples, the systems described herein may receive the wireless power and switch from an audio receiving mode into a power receiving mode.

In at least some embodiments, speaker coil of the device may be optimized to reproduce audio within a given radio frequency range (e.g., 100 Hz-20 kHz). Additionally or alternatively, the speaker coil may be designed to function as a wireless charging receiver within a specified radio frequency range (e.g., 80 kHz-300 kHz). In embodiments with multiple speaker coils, the frequency range for each speaker coil may be configurable and/or may be optimized for different frequency ranges in different types of electronic devices.

In some cases, a switch may be positioned electronically between an audio signal source (e.g., an application running on a mobile electronic device) and the speaker coil. That switch may be controlled via a logic chip such as a programmable logic device (PLD) or similar. For example, as illustrated in FIG. 3, a headset 300 may have a coil 302 that is controlled by a switch in a logic chip 304. In some embodiments, logic chip 304 may control various operations of headset 300 and/or coil 302, such as audio reproduction and charging.

In some examples, logic chip 304 may determine when to route audio signals to the speaker coil and when to initiate wireless charging. In cases where the speaker coils are part of AR glasses, the speaker coils may overlap each other when the glasses arms are folded down toward the lens frames. In this position (i.e., in a storage position), the overlapping speaker coils may provide improved wireless charging, as the overlapping speaker coils effectively form a larger coil with a greater ability to conduct electricity.

The systems described herein may switch modes in response to various triggers, such as detecting that audio signals are being received by the device, detecting that a user has switched the device into an “on” or “active” mode, detecting that the device is in physical proximity to a dock (e.g., physically touching the dock, within several inches of the dock, etc.), detecting that a user has switched the device into an “inactive” or “charging” mode, detecting that wireless power is being emitted in proximity to the device, and/or detecting that wireless data is being sent to the device.

Rather than each coil switching between different functions, in another embodiment, two coils may each have separate functions. For example, as illustrated in FIG. 4, a headset 400 may include an audio coil 402 and a charging coil 404 in one or both sides of headset 400. In some embodiments, audio coil 402 and charging coil 404 may be positioned coaxially to each other. In such cases, each of the two sets of coils may be separated by a dielectric. In this embodiment, each side of the headset or AR glasses may thus contain one of these coaxial coil/dielectric/coaxial coil pairs. In each pair, one of the speaker coils may be dedicated to reproducing audio and the other speaker coil may be dedicated to wireless charging.

In such embodiments, each of the two speaker coils in each speaker coil unit may be separately designed and may be of a different size, shape, material, density, and/or may have other differences. For example, the speaker coil designed for audio reproduction may have characteristics that lend it to be better at reproducing music while the speaker coil designed for wireless power charging may have characteristics that lend it to be better at wireless charging. This embodiment, while potentially having more weight due to the increased number of speaker coils, may provide highly efficient speaker coils that are each optimized for the potentially disparate jobs of reproducing audio and functioning as a wireless charging receiver.

In some embodiments, one or both coils may also perform data communication (e.g., with a dock, charging station, and/or any other device). In some cases, the data transfer may occur via low-bandwidth, passive communication that occurs when the wireless charger supplies power to the wireless charging coil. In other cases, a separate radio such as a near-field communication (NFC) device, a radio frequency identifier (RFID), or other passive communication device may be used in conjunction with the electronic device to facilitate communication. The data may be communicated through the speaker coil or other passive communication device wirelessly while the electronic device is charging wirelessly.

At least in some cases, the data communication may include authenticating the headset or glasses to a docking/charging station. For example, as illustrated in FIG. 5, a pair of glasses 502 may be placed on a dock 504. While glasses 502 are in contact with dock 504, a coil 506 within glasses 502 may receive power and/or data transmissions from dock 504. In some examples, glasses 502 may also send data transmission to dock 504. Though shown in an open position, in some embodiments, glasses 502 may charge more efficiently when folded closed and placed such that coil 506 is parallel to the surface of dock 504. Glasses 502 may send and receive various types of data, such as software updates and/or media content.

As described above, the systems and methods described herein may enable a device to charge wirelessly via a speaker coil, improving the charging abilities of the device. In some embodiments, a device may charge and reproduce audio signals via the same speaker coil that is used for charging while in other embodiments, a device may have a set of two speaker coils located coaxially that each perform a different function. Because of the small footprint of many wearable audio devices, such as headsets and AR glasses, charging via a speaker coil may enable a device to charge efficiently without adding additional hardware or ports to the device. Additionally, enabling wireless charging may make devices more user-friendly as a user has only to place the device on or near a dock, rather than connect pins or cables.

Embodiments of the present disclosure may include or be implemented in conjunction with various types of artificial reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial reality systems may be designed to work without near-eye displays (NEDs). Other artificial reality systems may include an NED that also provides visibility into the real world (such as, e.g., augmented-reality system 600 in FIG. 6) or that visually immerses a user in an artificial reality (such as, e.g., virtual-reality system 700 in FIG. 7). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent one or more of a variety of different sensing mechanisms, such as a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

In some examples, augmented-reality system 600 may also include a microphone array with a plurality of acoustic transducers 620(A)-620(J), referred to collectively as acoustic transducers 620. Acoustic transducers 620 may represent transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(1) and 620(J), which may be positioned on a corresponding neckband 605.

In some embodiments, one or more of acoustic transducers 620(A)-(J) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented-reality device 600 may simulate binaural hearing and capture a 3D stereo sound field around about a user's head. In some embodiments, acoustic transducers 620(A) and 620(B) may be connected to augmented-reality system 600 via a wired connection 630, and in other embodiments acoustic transducers 620(A) and 620(B) may be connected to augmented-reality system 600 via a wireless connection (e.g., a BLUETOOTH connection). In still other embodiments, acoustic transducers 620(A) and 620(B) may not be used at all in conjunction with augmented-reality system 600.

Acoustic transducers 620 on frame 610 may be positioned in a variety of different ways, including along the length of the temples, across the bridge, above or below display devices 615(A) and 615(B), or some combination thereof. Acoustic transducers 620 may also be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on their shoulders than they would tolerate on their heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620(1) and 620(J)) that are part of the microphone array (or potentially form their own microphone subarray). Neckband 605 may also include a controller 625 and a power source 635.

Acoustic transducers 620(1) and 620(J) of neckband 605 may be configured to detect sound and convert the detected sound into an electronic format (analog or digital). In the embodiment of FIG. 6, acoustic transducers 620(1) and 620(J) may be positioned on neckband 605, thereby increasing the distance between the neckband acoustic transducers 620(1) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented-reality system 600 to neckband 605 may reduce weight and heat in eyewear device 602, making it more comfortable to the user.

Power source 635 in neckband 605 may provide power to eyewear device 602 and/or to neckband 605. Power source 635 may include, without limitation, lithium ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUS), one or more tracking emitters or detectors, and/or any other suitable device or system for creating an artificial-reality experience.

Artificial reality systems may include a variety of types of visual feedback mechanisms. For example, display devices in augmented-reality system 600 and/or virtual-reality system 700 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial reality systems may include a single display screen for both eyes or may provide a display screen for each eye, which may allow for additional flexibility for varifocal adjustments or for correcting a user's refractive error. Some of these artificial reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial reality experience in one or more of these contexts and environments and/or in other contexts and environments.

### EXAMPLE EMBODIMENTS

Example 1: A device that includes a processor, memory, at least one speaker coil configured to reproduce audio signals and receive wireless power from a wireless power source, and a switch configured to switch the at least one speaker coil between reproducing the audio signals and receiving the wireless power from the wireless power source.

Example 2: The device of example 1, where the device includes a pair of artificial reality glasses.

Example 3: The device of examples 1-2, where the device includes an artificial reality headset.

Example 4: The device of examples 1-3, where the switch further switches to a data transfer function that allows the speaker coil to facilitate data transfer to a docking station.

Example 5: The device of examples 1-4, where the data transfer function enables the device to transfer data through the speaker coil wirelessly while the device is charging.

Example 6: The device of examples 1-5, where the at least one speaker coil is optimized to reproduce audio at a first range of radio frequencies and to function as a wireless charging receiver at a second range of radio frequencies that does not overlap the first range of radio frequencies.

Example 7: The device of examples 1-6, where the first range of radio frequencies includes 100 Hz-20 kHz and the second range of radio frequencies includes 80 kHz-300 kHz.

Example 8: The device of examples 1-7, where the switch is controlled via a logic chip that is configured to control audio reproduction and wireless charging.

Example 9: The device of examples 1-8, where the at least one speaker coil includes two speaker coils that are positioned coaxially to each other, each of the two speaker coils being part of a single unit that is separated by a dielectric.

Example 10: The device of examples 1-9, where a first speaker coil of the two speaker coils is designed to reproduce audio signals and a second speaker coil of the two speaker coils is designed to provide wireless charging.

Example 11: A computer-implemented method may include identifying a device that includes at least one speaker coil, receiving, via the at least one speaker coil, audio signals, and receiving, via the at least one speaker coil, wireless power.

Example 12: The computer-implemented method of example 11, where receiving the audio signals includes switching the at least one speaker coil, via a switch in the device, between a power receiving mode and an audio receiving mode.

Example 13: The computer-implemented method of examples 11-12, where receiving the wireless power includes switching the at least one speaker coil, via a switch in the device, between an audio receiving mode and a power receiving mode.

Example 14: The computer-implemented method of examples 11-13, where the device includes a pair of artificial reality glasses.

Example 15: The computer-implemented method of examples 11-14, where the device includes an artificial reality headset.

Example 16: The computer-implemented method of examples 11-15 may further include switching to a data transfer function that allows the at least one speaker coil to facilitate data transfer to a docking station.

Example 17: The computer-implemented method of examples 11-16, where the at least one speaker coil is optimized to reproduce audio at a first range of radio frequencies and to function as a wireless charging receiver at a second range of radio frequencies that does not overlap the first range of radio frequencies.

Example 18: The computer-implemented method of examples 11-17, where the at least one speaker coil includes two speaker coils that are positioned coaxially to each other, each of the two speaker coils being part of a single unit that is separated by a dielectric.

Example 19: The computer-implemented method of examples 11-18, where e a first speaker coil of the two speaker coils is designed to reproduce audio signals and a second speaker coil of the two speaker coils is designed to provide wireless charging.

Example 20: A system for wireless charging using a speaker coil may include at least one physical processor, physical memory including computer-executable instructions that, when executed by the physical processor, cause the physical processor to (i) identify a device that includes at least one speaker coil, (ii) receive, via the at least one speaker coil, audio signals, and (iii) receive, via the at least one speaker coil, wireless power.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a processor;
memory;
at least one speaker coil configured to reproduce audio signals and receive wireless power from a wireless power source; and
a switch configured to switch the at least one speaker coil between reproducing the audio signals and receiving the wireless power from the wireless power source.

2. The device of claim 1, wherein the device comprises a pair of artificial reality glasses.

3. The device of claim 1, wherein the device comprises an artificial reality headset.

4. The device of claim 1, wherein the switch further switches to a data transfer function that allows the speaker coil to facilitate data transfer to a docking station.

5. The device of claim 4, wherein the data transfer function enables the device to transfer data through the speaker coil wirelessly while the device is charging.

6. The device of claim 1, wherein the at least one speaker coil is optimized to reproduce audio at a first range of radio frequencies and to function as a wireless charging receiver at a second range of radio frequencies that does not overlap the first range of radio frequencies.

7. The device of claim 6, wherein the first range of radio frequencies comprises 100 Hz-20 kHz and the second range of radio frequencies comprises 80 kHz-300 kHz.

8. The device of claim 1, wherein the switch is controlled via a logic chip that is configured to control audio reproduction and wireless charging.

9. The device of claim 1, wherein the at least one speaker coil comprises two speaker coils that are positioned coaxially to each other, each of the two speaker coils being part of a single unit that is separated by a dielectric.

10. The device of claim 9, wherein a first speaker coil of the two speaker coils is designed to reproduce audio signals and a second speaker coil of the two speaker coils is designed to provide wireless charging.

11. A computer-implemented method comprising:
identifying a device that comprises at least one speaker coil;
receiving, via the at least one speaker coil, audio signals; and
receiving, via the at least one speaker coil, wireless power.

12. The computer-implemented method of claim 11, wherein receiving the audio signals comprises switching the at least one speaker coil, via a switch in the device, between a power receiving mode and an audio receiving mode.

13. The computer-implemented method of claim 11, wherein receiving the wireless power comprises switching the at least one speaker coil, via a switch in the device, between an audio receiving mode and a power receiving mode.

14. The computer-implemented method of claim 11, wherein the device comprises a pair of artificial reality glasses.

15. The computer-implemented method of claim 11, wherein the device comprises an artificial reality headset.

16. The computer-implemented method of claim 11, further comprising switching to a data transfer function that allows the at least one speaker coil to facilitate data transfer to a docking station.

17. The computer-implemented method of claim 11, wherein the at least one speaker coil is optimized to reproduce audio at a first range of radio frequencies and to function as a wireless charging receiver at a second range of radio frequencies that does not overlap the first range of radio frequencies.

18. The computer-implemented method of claim 11, wherein the at least one speaker coil comprises two speaker coils that are positioned coaxially to each other, each of the two speaker coils being part of a single unit that is separated by a dielectric.

19. The computer-implemented method of claim 18, wherein a first speaker coil of the two speaker coils is designed to reproduce audio signals and a second speaker coil of the two speaker coils is designed to provide wireless charging.

20. A system comprising:
at least one physical processor;
physical memory comprising computer-executable instructions that, when executed by the physical processor, cause the physical processor to:
identify a device that comprises at least one speaker coil;
receive, via the at least one speaker coil, audio signals; and
receive, via the at least one speaker coil, wireless power.
